(19) United States
(12) Patent Application Publication
(10) Pub. No.: US 2026/0100567 A1
(43) Pub. Date: Apr. 9, 2026

(54) Protective Cap for Cable Termination, Protective Assembly and Cable Assembly

(71) Applicants: Tyco Electronics (Shanghai) Co., Ltd., Shanghai (CN); Tyco Electronics Technology (SIP) Co., Ltd., Suzhou (CN)

(72) Inventors: Hai Wang, Suzhou (CN); Shuai (Ted) Yuan, Shanghai (CN); Chuanheng Zhai, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/351,870

(22) Filed: Oct. 7, 2025

(30) Foreign Application Priority Data
Oct. 8, 2024 (CN) 202422416953.8

(51) Int. Cl. H02G 15/02

(52) U.S. Cl. CPC H02G 15/02

(57) ABSTRACT

A protective assembly for a cable termination includes a protective cap and a protective cover. The protective cap includes a first cylinder body and a protrusion protruding radially and outwardly from an insertion end of the first cylinder body. The protective cover includes a stop and a second cylinder body having a side wall with an axial groove. The stop protrudes radially and inwardly from an inner surface of the side wall of the second cylinder body. The protrusion is slidable in the axial groove such that the insertion end of the first cylinder body is inserted into the second cylinder body. The first cylinder body is rotatable within the second cylinder body into a locking position where the protrusion interferes with the stop to prevent the protective cap from disengaging from the protective cover. The protective cap and the protective cover are sleeved on the cable termination.

### CROSS-REFERENCE TO RELATED APPLICATION

This application claims the benefit of the filing date under 35 U.S.C. § 119 (a)-(d) of Chinese Patent Application No. CN 202422416953.8 filed on Oct. 8, 2024, the whole disclosure of which is incorporated herein by reference.

### FIELD OF THE INVENTION

The present invention relates to a protective cap for a cable termination and, more particularly, to a protective cap for a cable termination and to a protective assembly for a cable termination and a cable assembly including the protective assembly.

### BACKGROUND OF THE INVENTION

A shielding ring is usually provided on an outside of a cable termination to prevent the influence of external electromagnetic interference on an internal signal of the cable, thereby ensuring the signal quality and reliability of the cable transmission. However, the shielding ring is prone to be damaged during the transportation of the cables. It is common to use wrapping materials to wrap the cable terminals to prevent damage to the shielding rings caused by improper transportation conditions or improper transportation methods. However, such methods cannot provide good protection for the shielding rings.

### SUMMARY OF THE INVENTION

A protective assembly for a cable termination includes a protective cap and a protective cover. The protective cap includes a first cylinder body and a protrusion protruding radially and outwardly from an insertion end of the first cylinder body. The protective cover includes a stop and a second cylinder body having a side wall with an axial groove. The stop protrudes radially and inwardly from an inner surface of the side wall of the second cylinder body. The protrusion is slidable in the axial groove such that the insertion end of the first cylinder body is inserted into the second cylinder body. The first cylinder body is rotatable within the second cylinder body into a locking position where the protrusion interferes with the stop to prevent the protective cap from disengaging from the protective cover. The protective cap and the protective cover are sleeved on the cable termination.

### BRIEF DESCRIPTION OF DRAWINGS

The invention will now be described by way of example with reference to the accompanying figures, of which:

FIG. 1 is a plan view of a cable termination with a protective assembly according to an exemplary embodiment;

FIG. 2 is a perspective view of a protective cap of the protective assembly of FIG. 1;

FIG. 3 is another perspective view of the protective cap of FIG. 2;

FIG. 4 is a perspective view of a protective cover (or a back cover of a connector) of the protective assembly of FIG. 1;

FIG. 5 is a cross-sectional view of the protective cover (or the back cover of the connector) of FIG. 4;

FIG. 6 is a perspective view of the protective cap of FIG. 2 and the protective cover (or the back cover of the connector) of FIG. 4 before assembling;

FIG. 7 is a perspective view of the protective cap of FIG. 2 and the protective cover (or the back cover of the connector) of FIG. 4 during assembling; and

FIG. 8 is a cross-sectional view of the protective assembly of FIG. 1 for the cable termination of FIG. 1.

### DETAILED DESCRIPTION

Although the present disclosure will be fully described with reference to the drawings containing preferred embodiments of the present disclosure, it should be understood that those skilled in the art may modify the present disclosure described herein and obtain the technical effect of the present disclosure. Therefore, it is necessary to understand that the description is a broad disclosure for those skilled in the art and is not intended to limit the exemplary embodiments described in the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

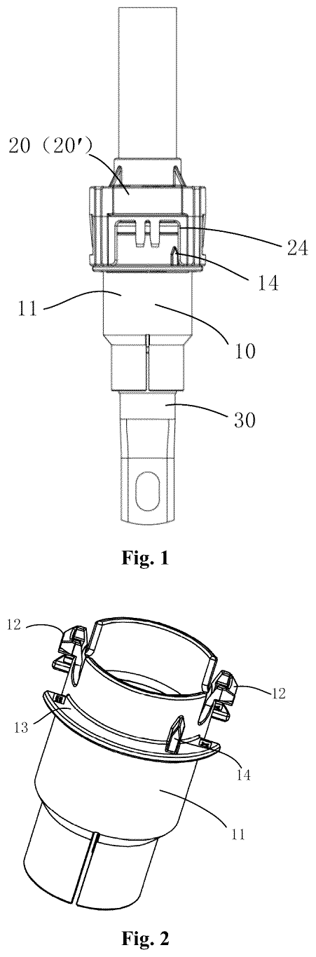

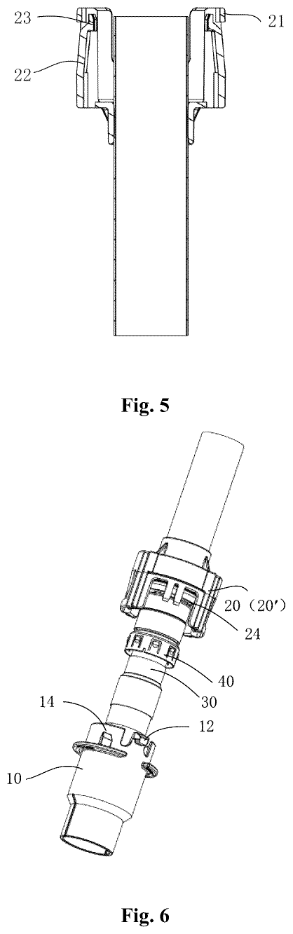

A protective assembly for a cable termination 30 will now be described with reference to FIGS. 1-8. As shown in FIGS. 1 and 6, the protective assembly includes a protective cap 10 and a protective cover 20, which are sleeved on the cable termination 30. As shown in FIGS. 2-3 and 7-8, the protective cap 10 includes a first cylinder body 11 and a protrusion 12 protruding radially and outwardly from an insertion end of the first cylinder body 11. The protective cover 20, as shown in FIGS. 4-5 and 7-8, includes a second cylinder body 21. A side wall of the second cylinder body 21 being provided with an axial groove 24, as shown in FIGS. 1, 4, and 6-7, which extends in a direction parallel to a central axis of the second cylinder body 21. The protective cover 20 further includes a stop 23, as shown in FIGS. 4-5 and 8, protruding radially and inwardly from an inner surface of the side wall of the second cylinder body 21. The protrusion 12 is slidable in the axial groove 24 so that the insertion end of the first cylinder body 11 is inserted into the second cylinder body 21. The first cylinder body 11 inserted into the second cylinder body 21 is rotatable in a first direction within the second cylinder body 21 into a locking position where the protrusion 12 of the protective cap 10 interferes with the stop 23 in the protective cover 20 in an axial direction, to prevent the protective cap 10 from disengaging from the protective cover 20 in the axial direction.

When assembling the protective assembly, first, the protrusion 12 of the protective cap 10 is aligned with the axial groove 24 of the protective cover 20. Then the insertion end of the protective cap 10 is inserted into the protective cover 20. When inserted in place, the protrusion 12 is axially located on the side of the stop 23 on the protective cover 20 away from the insertion end of the protective cover 20. Then the first cylinder body 11 is rotated relative to the second cylinder body 21 so that the protrusion 12 rotates to the position corresponding to the stop 23 in the axial direction. This causes the protrusion 12 to interfere with the stop 23 in the axial direction. During rotation, the protrusion 12 is compressed by the side wall of the protective cover 20 and deforms. When the protrusion 12 is rotated to the position corresponding to the stop 23 in the axial direction, the protective cap 10 can be placed against the protective cover 20 in a radial direction, and in the axial direction, due to the interference between the protrusion 12 and the stop 23, the protective cap 10 can be effectively prevented from being disengaged from the protective cover 20 in the axial direction.

The protective assembly according to the embodiments of the present disclosure interferes with the stop 23 of the protective cover 20 by rotating the protrusion 12 of the protective cap 10 into the locking position, which can enhance the retention force of the protective assembly, thereby better protecting a shielding ring 40 on the cable termination 30 to prevent damage to the shielding ring 40 caused by improper transportation conditions or improper transportation methods during the transportation of the cable. Further, the protective assembly has a simple structure, is easy to manufacture, convenient to operate, and can be reused. Furthermore, since both the protrusion 12 and the stop 23 are located inside the second cylinder body 21, they are not prone to misoperation or to cause disengagement of the protrusion 12 and the stop 23 in a drop, which further led to the disengagement of the protective cap 10 from the protective cover 20. When the protective assembly is not required, the first cylinder body 11 can be rotated in a direction opposite to the first direction to separate the protrusion 12 of the first cylinder body 11 from the stop 23 and rotate it to the position aligned with the axial groove 24, and then slide the protrusion 12 along the axial groove 24 so as to separate the protective cap 10 from the protective cover 20, and the protective cap 10 can be removed.

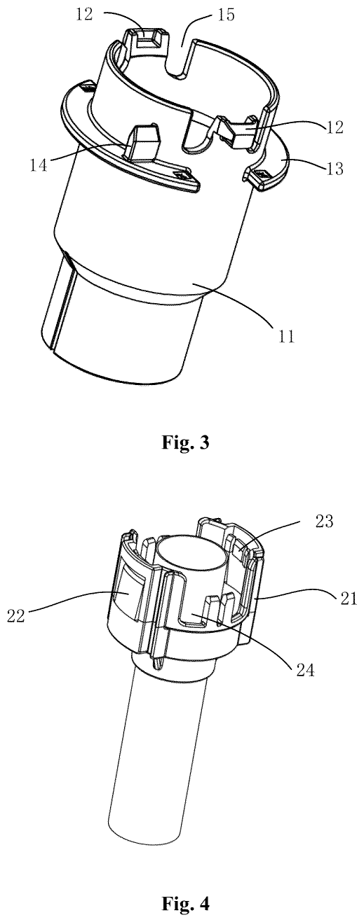

As shown in FIG. 3, the protrusion 12 is separated from the side wall of the first cylinder body 11 along a circumferential direction of the first cylinder body 11 via a notch 15, and a portion of the side wall of the first cylinder body 11 where the protrusion 12 is located is inclined away from a central axis of the first cylinder body 11 in a direction toward the insertion end of the first cylinder body 11. This can prevent damage to the shielding ring 40 on the cable termination 30 during assembling of the protective cap 10 and the protective cover 20. At the same time, when the first cylinder body 11 rotates within the second cylinder body 21, it can cause the protrusion 12 to undergo elastic deformation in the radial direction, so that the protrusion 12 of the first cylinder body 11 can be easily rotated to the position corresponding to the stop 23 of the second cylinder body 21.

As shown in FIG. 4, the second cylinder body 21 is formed with a cantilever 22 being inclined toward the insertion end of the second cylinder body 21 and toward the central axis of the second cylinder body 21, and the stop 23 is formed at a free end of the cantilever 22. The retention force of the protective assembly can be further enhanced by forming the stop 23 at the free end of cantilever 22.

As shown in FIG. 2, a number of the protrusions 12 of the protective cap 10 is two, and the two protrusions 12 are arranged at intervals along the circumferential direction of the first cylinder body 11, to improve reliability of the connection between the protective cap 10 and the protective cover 20, and ensure that the overall protective cap 10 and protective cover 20 are subjected to uniform force in the circumferential direction. It should be noted that, in some other embodiments of the present disclosure, the number of the protrusion(s) 12 can also be one, three or others, and the details should be designed according to the specific circumstances, and the present disclosure does not limit this. Furthermore, although the two protrusions 12, as shown in FIG. 2, are arranged at equal intervals along the circumferential direction of the first cylinder body 11, in some other embodiments, the protrusions 12 can also be arranged at unequal intervals along the circumferential direction of the first cylinder body 11.

As shown in FIGS. 2-3, an outer surface of the first cylinder body 11 is provided with a flange 13 protruding radially and outwardly. The flange 13 extends at least partially along the circumferential direction of the first cylinder body 11 and is configured to prevent the first cylinder body 11 from continuing to move along the insertion direction relative to the second cylinder body 21 after being inserted into a proper position in the second cylinder body 21. At this “proper position”, the protrusion 12 can be rotated to the position corresponding to the stop 23, thereby interfering with the stop 23.

As shown in FIGS. 1-3 and 6, the protective cap 10 is also provided with a barrier 14 configured to prevent the first cylinder body 11 from continuing to rotate along the first direction after rotating into the locking position. The barrier 14 is provided on the protective cap 10.

However, it should be noted that in some other embodiments of the present disclosure, the barrier 14 can also be provided on the protective cover 20. For example, the barrier 14 can be provided as a structure that protrudes radially and inwardly on the inner wall of the second cylinder body 21 of the protective cover 20. After the first cylinder body 11 rotates in the first direction to the locking position, the barrier 14 can interfere with the radially and outwardly protruding protrusions 12 on the first cylinder body 11 of the protective cap 10, so as to prevent the first cylinder body 11 from continuing to rotate in the first direction to ensure the reliability of the connection between the protective cap 10 and the protective cover 20.

The protective cap 10 also has a mistake-proof mechanism configured to prevent the first cylinder body 11 from being inserted into the second cylinder body 21 when the protrusion 12 is not aligned with the axial groove 24. This can reduce misoperation and improve work efficiency. As shown in FIGS. 2-3, the barrier 14 is provided on the flange 13 and the barrier 14 also serves as the mistake-proof mechanism. That is to say, the barrier 14 serves as both a stopper and the mistake-proof mechanism, which can reduce the cost and is easy to manufacture. However, it should be noted that in some other embodiments of the present disclosure, the barrier 14 and the mistake-proof mechanism can also be two separate components.

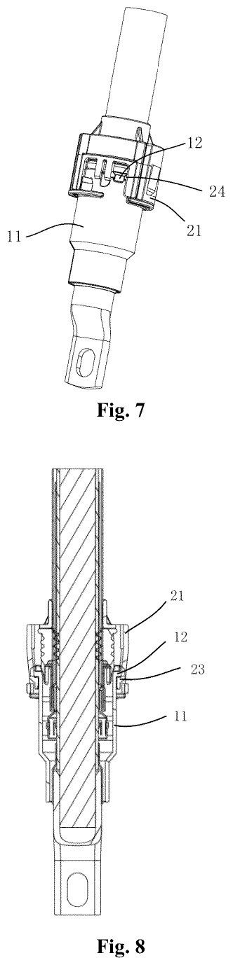

As shown in FIG. 7, a guiding surface is provided on a side of the axial groove 24 to guide the protrusion 12 to rotate along the first direction.

According to another aspect of the present disclosure, there is also provided a protective cap for a cable termination 30. The protective cap may be the protective cap 10 described above. As shown in FIG. 1, the cable termination 30 is mounted on a back cover 20′ of a connector. The back cover 20′ has a second cylinder body 21. In particular, the protective cap 10 includes a first cylinder body 11 and a protrusion 12 protruding radially and outwardly from an insertion end of the first cylinder body 11, and the protrusion 12 is slidable in the axial groove 24 provided in a side wall of the second cylinder body 21 of the back cover 20′ so that the first cylinder body 11 is inserted into the second cylinder body 21 of the back cover 20′. The first cylinder body 11 inserted into the second cylinder body 21 is rotatable within the second cylinder body 21 so that the protrusion 12 is rotatable in a first direction into a locking position where the protrusion 12 of the protective cap 10 interferes with the stop 23 protruding radially and inwardly from an inner surface of a side wall of the back cover 20′ to prevent the protective cap 10 from being disengaged from the back cover 20′ in an axial direction.

When assembling, first, the protrusion 12 of the protective cap 10 is aligned with the axial groove 24 of the back cover 20′. Then the insertion end of the protective cap 10 is inserted into the back cover 20′. When inserted in place, the protrusion 12 is axially located on the side of the stop 23 on the back cover 20′ away from the insertion end of the back cover 20′. Then the first cylinder body 11 is rotated relative to the second cylinder body 21 so that the protrusion 12 rotates to the position corresponding to the stop 23 in the axial direction. This causes the protrusion 12 to interfere with the stop 23 in the axial direction. During rotation, the protrusion 12 is compressed by the side wall of the back cover 20′ and deforms. When the protrusion 12 is rotated to the position corresponding to the stop 23 in the axial direction, the protective cap 10 can be placed against the back cover 20′ in a radial direction, and in the axial direction, due to the interference between the protrusion 12 and the stop 23, the protective cap 10 can be effectively prevented from being separated from the protective cover 20 in the axial direction.

During the cable transportation, the protective cap 10 is assembled with the back cover 20′ of the connector on which the cable termination 30 is mounted. The interference between the protective cap 10 and the stop 23 of the back cover 20′ prevents the protective cap 10 from being disengaged from the back cover 20′ in the axial direction, thereby better protecting the shielding ring 40 installed on the cable termination 30 of the connector to prevent damage to the shielding ring 40 caused by improper transportation conditions or improper transportation methods during the transportation of the cable. When it is required to connect the connector to a mating connector, the first cylinder body 11 can be rotated in a direction opposite to the first direction to separate the protrusion 12 of the first cylinder body 11 from the stop 23 and rotate it to the position aligned with the axial groove 24, and then slide the protrusion 12 along the axial groove 24 so as to separate the protective cap 10 from the back cover 20′, and then the mating connector mated with this connector can be plugged into this connector. The protective cap 10 according to the present disclosure can be used in conjunction with the back cover 20′ of the existing connector for the cable termination 30 so as to further reduce the manufacturing cost.

As shown in FIG. 3, the protrusion 12 is separated from the side wall of the first cylinder body 11 along a circumferential direction of the first cylinder body 11 via a notch 15, and a portion of the side wall of the first cylinder body 11 where the protrusion 12 is located is inclined away from a central axis of the first cylinder body 11 in a direction toward the insertion end of the first cylinder body 11. This can prevent damage to the shielding ring 40 on the cable termination 30 during assembling of the protective cap 10 and the back cover 20′. At the same time, when the first cylinder body 11 rotates within the second cylinder body 21, it can cause the protrusion 12 to undergo elastic deformation in the radial direction, so that the protrusion 12 of the first cylinder body 11 can be easily rotated to the position corresponding to the stop 23 of the second cylinder body 21.

As shown in FIG. 4, the second cylinder body 21 is formed with a cantilever 22 being inclined toward the insertion end of the second cylinder body 21 and toward the central axis of the second cylinder body 21, and the stop 23 is formed at a free end of the cantilever 22. The retention force of the protective assembly can be further enhanced by forming the stop 23 at the free end of cantilever 22.

As shown in FIG. 2, a number of the protrusions 12 of the protective cap 10 is two, and the two protrusions 12 are arranged at intervals along the circumferential direction of the first cylinder body 11, to improve reliability of the connection between the protective cap 10 and the protective cover 20, and ensure that the overall protective cap 10 and protective cover 20 are subjected to uniform force in the circumferential direction. It should be noted that, in some other embodiments of the present disclosure, the number of the protrusion(s) 12 can also be one, three or others, and the details should be designed according to the specific circumstances, and the present disclosure does not limit this. Furthermore, although the two protrusions 12, as shown in FIG. 2, are arranged at equal intervals along the circumferential direction of the first cylinder body 11, in some other embodiments of the present disclosure, the protrusions 12 can also be arranged at unequal intervals along the circumferential direction of the first cylinder body 11.

As shown in FIGS. 2-3, an outer surface of the first cylinder body 11 is provided with a flange 13 protruded radially and outwardly. The flange 13 extends at least partially along the circumferential direction of the first cylinder body 11 and is configured to prevent the first cylinder body 11 from continuing to move along the insertion direction relative to the second cylinder body 21 after being inserted into a proper position of the second cylinder body 21. At this “proper position”, the protrusion 12 can rotate to the position corresponding to the stop 23, thereby interfering with the stop 23.

As shown in FIGS. 1-3 and 6, the protective cap 10 is also provided with a barrier 14 configured to prevent the first cylinder body 11 from continuing to rotate along the first direction after rotating into the locking position. The barrier 14 is provided on the protective cap 10.

However, it should be noted that in some other embodiments of the present disclosure, the barrier 14 can also be provided on the protective cover 20. For example, the barrier 14 can be provided as a structure that protrudes radially and inwardly on the inner wall of the second cylinder body 21 of the protective cover 20. After the first cylinder body 11 rotates in the first direction to the locking position, the barrier 14 can interfere with the radially and outwardly protruding protrusions 12 on the first cylinder body 11 of the protective cap 10, so as to prevent the first cylinder body 11 from continuing to rotate in the first direction to ensure the reliability of the connection between the protective cap 10 and the protective cover 20.

The protective cap 10 also has a mistake-proof mechanism configured to prevent the first cylinder body 11 from being inserted into the second cylinder body 21 when the protrusion 12 is not aligned with the axial groove 24. This can reduce misoperation and improve work efficiency. As shown in FIGS. 2-3, the barrier 14 is provided on the flange 13 and also serves as the mistake-proof mechanism. That is to say, the barrier 14 serves as both a stopper and the mistake-proof mechanism, which can reduce the cost and is easy to manufacture. However, it should be noted that in some other embodiments of the present disclosure, the barrier 14 and the mistake-proof mechanism can also be two separate components.

According to yet another aspect of the present disclosure, there is provided a cable assembly. The cable assembly includes a cable termination 30 and the abovementioned protective assembly for the cable termination 30.

According to the protective cap 10 for the cable termination 30, the protective assembly and the cable assembly provided by the aforementioned embodiments of the present disclosure, the protrusion 12 of the protective cap 10 interferes with the stop 23 of the protective cover 20 of the protective assembly (or with the stop 23 of the back cover 20′ of the connector where the cable terminal is mounted) by rotating the protrusion 12 into the locking position, which enhances the retention force of the protective assembly. Further, the protective assembly has a simple structure, is easy to manufacture, convenient to operate, and can be reused. Furthermore, since both the protrusion 12 and the stop 23 are located inside the second cylinder body 21 of the protective cover 20, they are not prone to misoperation or to cause disengagement of the protrusion 12 and the stop 23 in a drop, which further led to the disengagement of the protective cap 10 from the protective cover 20. Thus, the shielding ring 40 on the cable termination 30 is protected well to prevent damage to the shielding ring 40 caused by improper transportation conditions or improper transportation methods during the transportation of the cable.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate the preferred embodiments of the present disclosure by way of example, and should not be construed as limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “comprise” or “include” does not exclude other elements or steps, and the word “a” or “an” does not exclude more than a plurality. In addition, any reference numerals in the claims should not be interpreted as the limitation to the scope of the present disclosure.

1. A protective assembly for a cable termination, comprising:
a protective cap including a first cylinder body and a protrusion protruding radially and outwardly from an insertion end of the first cylinder body; and
a protective cover including a stop and a second cylinder body having a side wall with an axial groove, the stop protrudes radially and inwardly from an inner surface of the side wall of the second cylinder body, the protrusion is slidable in the axial groove such that the insertion end of the first cylinder body is inserted into the second cylinder body, the first cylinder body is rotatable in a first direction within the second cylinder body into a locking position where the protrusion interferes with the stop to prevent the protective cap from disengaging from the protective cover in an axial direction, the protective cap and the protective cover are sleeved on the cable termination.

2. The protective assembly of claim 1, wherein the protrusion is separated from a side wall of the first cylinder body along a circumferential direction of the first cylinder body via a notch, a portion of the side wall of the first cylinder body where the protrusion is located is inclined away from a central axis of the first cylinder body in a direction toward the insertion end of the first cylinder body.

3. The protective assembly of claim 2, wherein the second cylinder body has a cantilever inclined toward an insertion end of the second cylinder body and toward a central axis of the second cylinder body, the stop is formed at a free end of the cantilever.

4. The protective assembly of claim 1, wherein the protective cap has a plurality of protrusions, the protrusions are arranged at intervals along a circumferential direction of the first cylinder body.

5. The protective assembly of claim 1, wherein an outer surface of the first cylinder body has a flange protruding radially and outwardly, the flange extends at least partially along a circumferential direction of the first cylinder body and prevents the first cylinder body from continuing to move along an insertion direction relative to the second cylinder body after being inserted into a rotatable position of the second cylinder body.

6. The protective assembly of claim 5, wherein the protective cap has a barrier preventing the first cylinder body from continuing to rotate along the first direction after rotating into the locking position.

7. The protective assembly of claim 6, wherein the protective cap has a mistake-proof mechanism preventing the first cylinder body from being inserted into the second cylinder body when the protrusion is not aligned with the axial groove.

8. The protective assembly of claim 7, wherein the barrier is provided on the flange.

9. The protective assembly of claim 8, wherein the barrier serves as the mistake-proof mechanism.

10. The protective assembly of claim 1, wherein a guiding surface is provided on a side of the axial groove to guide the protrusion to rotate along the first direction.

11. A protective cap for a cable termination, comprising:
a first cylinder body and a protrusion protruding radially and outwardly from an insertion end of the first cylinder body, the cable termination is mounted on a back cover of a connector, the back cover has a second cylinder body, the protrusion is slidable in an axial groove in a side wall of the second cylinder body such that the first cylinder body is inserted into the second cylinder body, the first cylinder body is rotatable within the second cylinder body such that the protrusion is rotatable in a first direction into a locking position where the protrusion interferes with a stop protruding radially and inwardly from an inner surface of a side wall of the back cover to prevent the protective cap from disengaging from the back cover in an axial direction.

12. The protective cap of claim 11, wherein the protrusion is separated from the side wall of the first cylinder body along a circumferential direction of the first cylinder body via a notch.

13. The protective cap of claim 11, wherein a portion of the side wall of the first cylinder body where the protrusion is located is inclined away from a central axis of the first cylinder body in a direction toward the insertion end of the first cylinder body.

14. The protective cap of claim 11, wherein the protective cap has a plurality of protrusions.

15. The protective cap of claim 14, wherein the protrusions are arranged at intervals along a circumferential direction of the first cylinder body.

16. The protective cap of claim 11, wherein the protective cap has a barrier preventing the first cylinder body from continuing to rotate along the first direction after rotating along the first direction into the locking position.

17. The protective cap of claim 11, wherein the protective cap has a mistake-proof mechanism preventing the first cylinder body from being inserted into the second cylinder body when the protrusion is not aligned with the axial groove.

18. A cable assembly, comprising:
a cable termination; and
a protective assembly including a protective cap and a protective cover, the protective cap includes a first cylinder body and a protrusion protruding radially and outwardly from an insertion end of the first cylinder body, the protective cover includes a stop and a second cylinder body having a side wall with an axial groove, the stop protrudes radially and inwardly from an inner surface of the side wall of the second cylinder body, the protrusion is slidable in the axial groove such that the insertion end of the first cylinder body is inserted into the second cylinder body, the first cylinder body is rotatable in a first direction within the second cylinder body into a locking position where the protrusion interferes with the stop to prevent the protective cap from disengaging from the protective cover in an axial direction, the protective cap and the protective cover are sleeved on the cable termination.
